(19) United States
(12) Patent Application Publication
(10) Pub. No.: US 2003/0235056 A1
(43) Pub. Date: Dec. 25, 2003

(54) High/low switching mechanism of vehicle headlight

(76) Inventor: Jung-Chang Jong, Chungli City (TW)

Correspondence Address: SUPREME PATENT SERVICES, POST OFFICE BOX 2339, SARATOGA, CA, 95070, US

(21) Appl. No.: 10/178,159

(22) Filed: Jun. 22, 2002

(51) Int. Cl. B60Q 1/04

(52) U.S. Cl. 362/512; 362/282; 362/319

(57) ABSTRACT

A vehicle headlight includes a light source, such as a light bulb, arranged inside a concave reflector. A mechanism is incorporated in the headlight for switching between high beam and low beam of the headlight. The switching mechanism includes a base fixed inside the vehicle headlight and retaining the light bulb. A frame is mounted to the base. Two shielding members are pivotally mounted to the frame on opposite sides of the bulb. A control plate is pivoted to the base and driven by a solenoid between active and inactive positions. A link bar has an end attached to the control plate and an opposite end pivoted to the shielding members whereby when the control plate is driven to the active position by the solenoid, the shielding members are rotated, by being driven by the pivotal connection between the link bar and the shielding members, to a position where the shielding members partially shield the light bulb and block a portion of light generated by the light bulb incident upon the reflector thereby realizing the low beam of the vehicle headlight, and when the control plate is moved to the inactive position by the solenoid, the shielding members are rotated away from the light bulb and no longer block the light generated by the light bulb thereby realizing the high beam of the vehicle headlight.

### FIELD OF THE INVENTION

The present invention relates generally to a vehicle headlight, and in particular to a mechanism for switching between high beam and low beam of the vehicle headlight.

### BACKGROUND OF THE INVENTION

Vehicles or automobiles are provided with headlight for driving in dark environments. The headlight comprises one or more light sources, such as bulbs, generating light beams and a reflector that reflects and selectively projects the light beams in different angles, which are commonly referred to as “high beam” and “low beam”. A conventional headlight comprises a bulb inside which two sets of lighting filaments are arranged. One of the filaments is shielded while another filament is not. The light generated by the unshielded filament is not constrained and allowed to orient to a high and thus far location and is thus called “high beam” while the light generated by the shielded filament is constrained to a low and thus near location and is thus called “low beam”.

Some of the vehicle headlights available in the market comprise a high intensity discharge (HID) lamp for providing high luminous intensity. The HID lamp comprises a hermetic chamber inside which ions are filled. The ions discharge and generate light when a sufficient electric field is applied to the lamp. Since the light of a HID lamp is generated by electrical discharge, each HID lamp has a single light source. Thus, a vehicle headlight must be comprised of two HID lamps in order to selectively generate high beam and low beam. This apparently increases the overall costs of the headlight.

A headlight comprising a bulb movable with respect to a reflector for changing relative position therebetween is also available. By changing the relative position between the bulb and the reflector, the light beam of the bulb is projected in different angles and thus switched between “high beam” and “low beam”. Since the relative position of the bulb with respect to the reflector is not fixed, the bulb cannot be properly positioned in a focal point of the reflector all the time and the light beam cannot be properly focused. This may lead to incorrect perception of other drivers with respect to the distance between the vehicle issuing the non-properly focused light and their cars and thus causing traffic accidents.

It is thus desired to have a mechanism for switching high beam and low beam of a vehicle headlight for overcoming the above problems.

### SUMMARY OF THE INVENTION

An object of the present invention is to provide a mechanism for switching high beam and low beam of a vehicle headlight by selectively moving shielding members to partially shield a single and properly positioned light source of the headlight.

Another object of the present invention is to provide a mechanism for switching high beam and low beam of a vehicle headlight without moving a light source of the headlight with respect to a reflector thereby simplifying the overall structure of the headlight and reducing the costs thereof.

To achieve the above object, in accordance with the present invention, there is provided a mechanism for switching high beam and low beam of a vehicle headlight, comprising a base fixed inside the vehicle headlight and retaining the light bulb. A frame is mounted to the base. Two shielding members are pivotally mounted to the frame on opposite sides of the bulb. A control plate is pivoted to the base and driven by a solenoid between active and inactive positions. A link bar has an end attached to the control plate and an opposite end pivoted to the shielding members whereby when the control plate is driven to the active position by the solenoid, the shielding members are rotated, by being driven by the pivotal connection between the link bar and the shielding members, to a position where the shielding members partially shield the light bulb and block a portion of light generated by the light bulb incident upon the reflector thereby realizing the low beam of the vehicle headlight, and when the control plate is moved to the inactive position by the solenoid, the shielding members are rotated away from the light bulb and no longer block the light generated by the light bulb thereby realizing the high beam of the vehicle headlight.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a vehicle headlight in which a switching mechanism in accordance with the present invention is embodied;

FIG. 2 is an exploded view of the vehicle headlight incorporating the switching mechanism of the present invention;

FIG. 3 is a side elevational view showing the switching mechanism at an active position;

FIG. 4 is similar to FIG. 3 but showing the switching mechanism at an inactive position;

FIG. 5 is a top plan view showing the switching mechanism at the active position; and

FIG. 6 is similar to FIG. 5 but showing the switching mechanism at the inactive position.

### DETAILED DESCRIPTION OF THE INVENTION

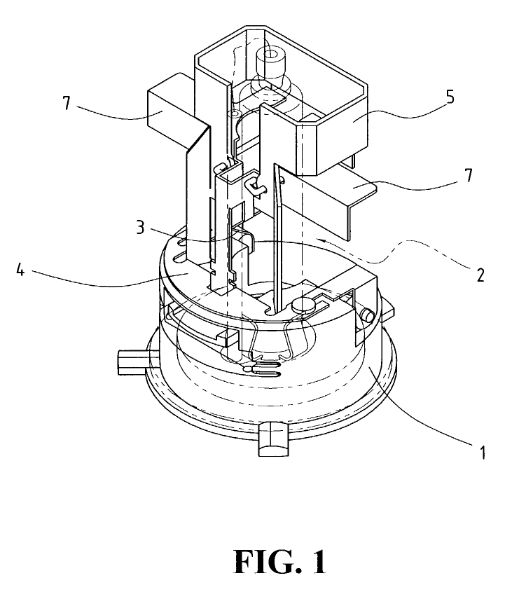

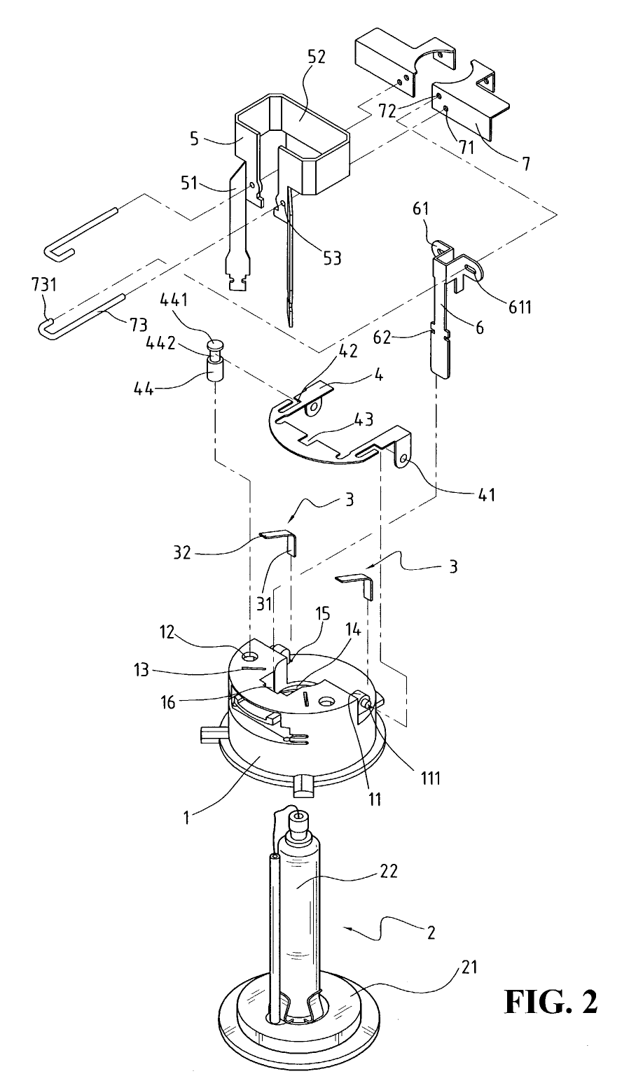

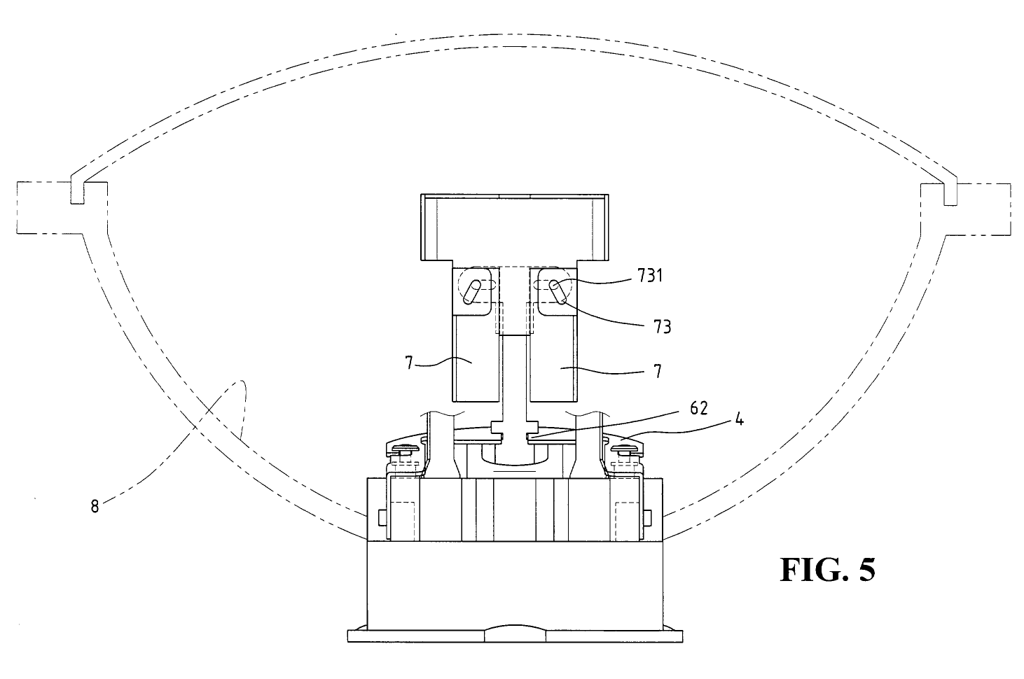

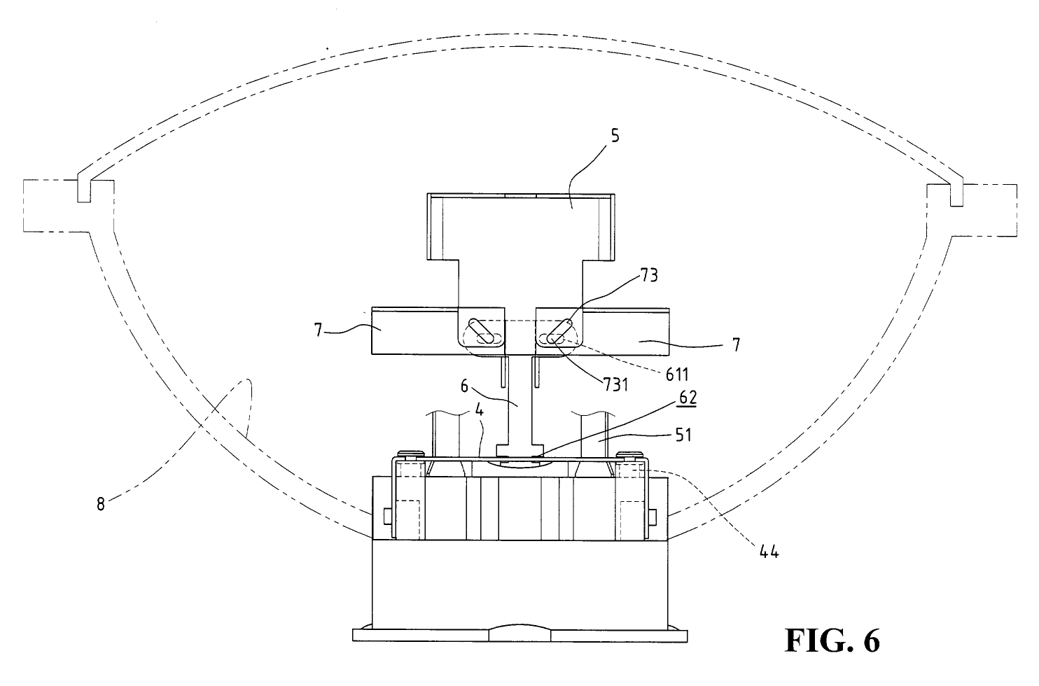

With reference to the drawings and in particular to FIGS. 1 and 2, a vehicle headlight comprises a holder or a base 1 fixed inside a concave reflector 8 (see phantom lines of FIGS. 5 and 6) of the headlight. An illuminator 2, such as a high intensity discharge (HID) bulb, is attached to the holder 1 for being positioned in the focal point of the concave reflector 8. The illuminator 2 generates a light beam that is reflected and projected by the concave reflector 8. A switching mechanism constructed in accordance with the present invention is incorporated in the headlight for selectively and partially blocking the light generated by the illuminator 2 thereby switching angular orientation of the light beam projected by the reflector 8.

The holder 1 defines a central bore 14 in which the illuminator 2 is received and fixed. The illuminator 2 comprises a base member 21 on which a bulb 22, such as a HID bulb, is fixed. The base member 21 is attached to an underside of the holder 1 by any known manner with the bulb 22 extending through the bore 14.

The holder 1 has a raised portion (not labeled) partially surrounding the central bore 14 and having a top face (not labeled) in which slits 13 are defined. A frame 5 defining a chamber 52 has legs 51 received in slits 13 and fixed to the raised portion of the holder 1 with the bulb 22 partially accommodated in the chamber 52.

Two opposite projections 11 are formed on the holder 1 and each forms a pivot 111 extending in opposite directions. A control plate 4, substantially U-shaped, has two opposite side segments connected by a central segment (both not labeled). Two opposite lugs (not labeled) corresponding to the projections 11 of the holder 1 are respectively formed on the side segments of the control plate 4 and each defines a hole 41 rotatably receiving the corresponding pivot 111 thereby pivotally attaching the control plate 4 to the holder 1.

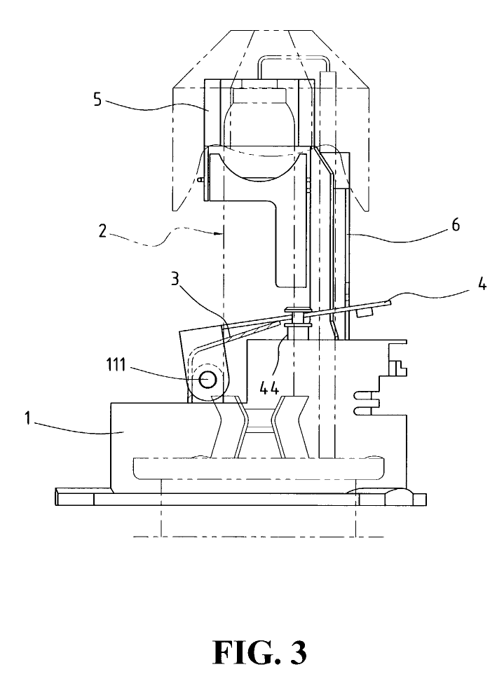

A biasing element 3 is mounted between the holder 1 and each side segment of the control plate 4 to bias the control plate 4 to an active position, as shown in FIGS. 3 and 5, which will be further discussed. In the embodiment illustrated, the biasing element 3 comprises a leaf spring having an end 31 received and fixed in a slit 15 defined in the holder 1 and an opposite end 32 engaging an underside of the corresponding side segment of the control plate 4 for biasing the control plate 4.

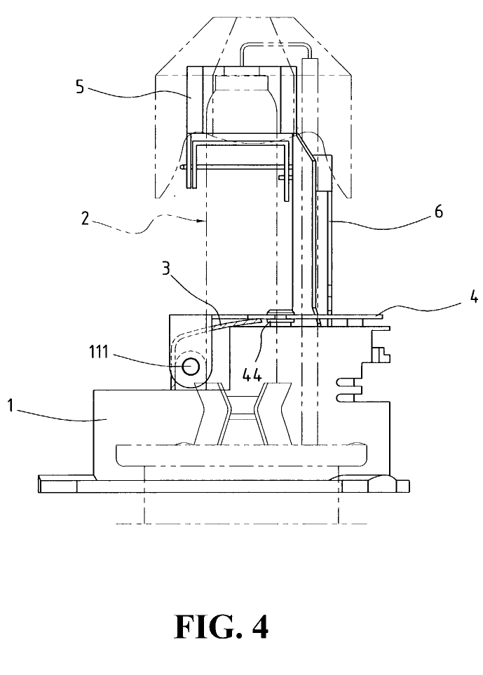

Two holes 12 are defined in the raised portion of the holder 1, each movably receiving a stem 44 which is driven by a driving unit (not shown) arranged inside the holder 1 to move along the hole 12. Each stem 44 has a neck 442 and forms an expanded free end 441. The neck 442 of the stem 44 is received in a slot 42 defined in each side segment of the control plate 4 and fixed together by the expanded end 441 engaging the side segment of the control plate 4. In the embodiment illustrated, the slot 42 is made L-shaped having a major section (not labeled) retaining the neck 442 of the stem 44 and a minor section (not labeled) forming an opening toward a side edge of the side segment for entry of the neck 442 of the stem 44 into the slot 42. The major section of the slot 42 is dimensioned to allow a limited relative movement between the neck 442 of the stem 44 and the control plate 4. The L-shaped configuration of the slot 42 prevents the stem 44 from detaching from the control plate 4. When the stems 44 are driven by the driving unit into the holes 12, the control plate 4 is moved by the stems 44, against the biasing elements 3, from the active position showing FIGS. 3 and 5 toward an inactive position as shown in FIGS. 4 and 6.

Two shielding members 7 are pivotally mounted to the frame 5 on opposite sides of the bulb 22 by means of pivot shafts 73 extending through aligned holes 53, 71 defined in the frame 5 and the shielding members 7 whereby the shielding members 7 are rotatable with respect to the bulb 22. A link bar 6 has a first end coupled to the control plate 4 and an opposite second end forming two lugs 61 corresponding to the shielding members 7. Each lug 61 forms a slot 611. A connection shaft 731 extends through the slot 611 of each lug 61 of the link bar 6 and a hole 72 defined in the corresponding shielding member 7 whereby when the link bar 6 is moved by the rotation of the control plate 4 about the pivots 111, the shielding members 7 are driven by the connection shafts 731 to rotate about the pivot shafts 73 between an active position shown in FIGS. 3 and 5 and an inactive position shown in FIGS. 4 and 6.

In the embodiment illustrated, the connection shaft 731 is attached to the pivot shaft 73 by a cross bar (not labeled) whereby the connection shaft 731 and the pivot shaft 73 form a unitary, J-shaped member. However, it is apparent to those having ordinary skills to provide separate pivot shaft 73 and connection shaft 731 for achieving the same functions.

The first end of the link bar 6 forms two opposite slits 62 on opposite edges thereof. The central segment of the control plate 4 defines a notch 43 sized to receive the first end of the link bar 6 therein with opposite edges of the notch 43 received in and engaging the slits 62 of the link bar 6 to couple the link bar 6 to the control plate 4. The raised portion of the holder 1 may form a passageway 16 for accommodating and guiding the movement of the link bar 6.

Referring to FIGS. 3-6, when the driving unit is not actuated and the control plate 4 is biased by the biasing elements 3 to the active position as shown in FIGS. 3 and 5, the shielding members 7 that have an extension having an L-shaped cross section, partially cover and shield the bulb 22 on opposite sides and top side (FIG. 5) thereof, whereby the light from the bulb 22 is partially blocked from being incident upon an upper portion of the reflector 8. The light beam projected by the reflector 8 is thus directed toward a low angle and realizing a low beam.

By actuating the driving unit, the control plate 4 is moved by means of the stems 44 to the inactive position as shown in FIGS. 4 and 6. The shielding members 7 are moved away from and thus completely exposing the bulb 22 toward the reflector 8 (FIG. 6). The light generated by the bulb 22 is completely incident upon the reflector 22, which in turn projects the light with a high angle and thus realizing a high beam.

The driving unit that drives the stems 44 and thus the control plate 4 can be of any known structure. For example, an electrically-excited magnetic force generation device, such as a solenoid, can be employed to attract and move the stems 44 that are made of ferromagnetic materials. Alternatively, a mechanical coupling can be employed to couple the stems 44 to the driving unit. The structure of the driving unit is beyond the scope of the present invention and will not be further discussed herein.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A mechanism for switching between first and second status of a vehicle headlight comprising a light source, the mechanism comprising:
a base fixed inside the vehicle headlight;
at least one shielding member pivotally mounted to the base by a pivot shaft to be movable between first and second positions;
a driving unit coupled to the shielding member for selectively moving the shielding member from the first position to the second position; wherein when the shielding member is at the first position, the shielding member partially shields the light source and blocks a portion of light generated by the light source thereby realizing the first status of the vehicle headlight, and when the shielding member is at the second position, the shielding member is moved away from the light source and no longer blocks the light generated by the light source thereby realizing the second status of the vehicle headlight.

2. The mechanism as claimed in claim 1, wherein a control plate is pivoted to the base and biased toward the first position by a biasing element, a link bar having a first end attached to the control plate and a second end pivotally attached to the shielding member at a position different from the pivot shaft whereby when the control plate is forced by the driving unit against the biasing element toward the second position, the link bar rotates the shielding member toward the second position.

3. The mechanism as claimed in claim 2, wherein the biasing element comprises a leaf spring.

4. The mechanism as claimed in claim 2, wherein the control plate defines a slot, and wherein a stem movable with respect to the base between the first and second positions by being driven by the driving unit has a neck portion received in and engaging the slot of the control plate for coupling the control plate to the driving unit.

5. The mechanism as claimed in claim 1 further comprising a frame mounted to the base, two shielding members being pivoted to the frame on opposite sides of the light source by pivot shafts, the shielding members being coupled to the driving unit to be driven thereby between the first and second positions.

6. The mechanism as claimed in claim 5, wherein the shielding members comprise an L-shaped extension.

7. The mechanism as claimed in claim 5, wherein the coupling between the shielding members and the driving unit comprises a link bar forming two lugs each defining a slot, a connection shaft extending through the slot of the lug and a hole defined in the corresponding shielding member whereby when the link bar is driven by the driving unit, the shielding member is rotated between the first and second positions.

8. The mechanism as claimed in claim 7, wherein the connection shaft is attached to the pivot shaft by a cross bar to form a unitary member.

9. The mechanism as claimed in claim 1, wherein the driving unit comprises an electrically-excited device.

10. The mechanism as claimed in claim 9, wherein the electrically-excited device comprises a solenoid.
